(19) United States
(12) Patent Application Publication
(10) Pub. No.: US 2024/0112594 A1
(43) Pub. Date: Apr. 4, 2024

(54) SOFTWARE APPLICATIONS FOR FINANCIAL EDUCATION

(71) Applicant: Wells Fargo Bank, N.A., San Francisco, CA (US)

(72) Inventors: Mosiah Monroe-Estes, Vallejo, CA (US); Alan W. Hecht, San Francisco, CA (US)

(21) Appl. No.: 17/936,897

(22) Filed: Sep. 30, 2022

(51) Int. Cl. G09B 19/00; G06Q 20/26; G06Q 20/40

(52) U.S. Cl. CPC G09B 19/00; G06Q 20/26; G06Q 20/40

(57) ABSTRACT

An example computer system for providing financial education can include: one or more processors; and non-transitory computer-readable storage media encoding instructions which, when executed by the one or more processors, causes the computer system to generate: a financial account module programmed to provide a first user and a second user access to a financial account; an education module programmed to provide educational material related to finances, the education module tailoring the educational material based upon a level of sophistication of the first user, wherein the level of sophistication is set by the second user or is determined based on an attribute of the first user; and a communication module programmed to facilitate communication between the first user and the second user relating to the finances of the first user.

### BACKGROUND

Every generation of parents laments that their children do not know the value of a “dollar”. Teaching children how to manage money and preparing them for a life of financial security can be difficult. This is compounded by the complexity of today's investments. Simply giving an allowance no longer provides a child with the necessary skills to be financially successful as an adult.

### SUMMARY

Embodiments disclosed herein are directed to software applications that provide for a financial education. In various examples, the software applications allow parents to teach children financial responsibility.

According to one aspect, an example computer system for providing a financial education can include: one or more processors; and non-transitory computer-readable storage media encoding instructions which, when executed by the one or more processors, causes the computer system to generate: a financial account module programmed to provide a first user and a second user access to a financial account, wherein the first user is associated with a first user credential, wherein the second user is associated with a second login credential, wherein the first user has a restricted level of access to the financial account, and wherein the second user has an unrestricted level of access to the financial account; an education module programmed to provide educational material related to finances, the education module tailoring the educational material based upon a level of sophistication of the first user, wherein the level of sophistication is set by the second user or is determined based on an attribute of the first user; and a communication module programmed to facilitate communication between the first user and the second user relating to the finances of the first user.

According to another aspect, a computer-implemented method for providing a financial education can include: providing, by a computing device, a first user and a second user access to a financial account, wherein the first user is associated with a first user credential, wherein the second user is associated with a second login credential, wherein the first user has a restricted level of access to the financial account, and wherein the second user has an unrestricted level of access to the financial account; providing educational material related to finances, the education module tailoring the educational material based upon a level of sophistication of the first user, wherein the level of sophistication is set by the second user or is determined based on an attribute of the first user; and facilitating communication between the first user and the second user relating to the finances of the first user.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for providing a financial education to a child.

FIG. 2 shows example logical components of a child device of the system of FIG. 1.

FIG. 3 shows an example graphical user interface of a software application of the child device of FIG. 2.

FIG. 4 shows example physical components of the child device of FIG. 2.

### DETAILED DESCRIPTION

This disclosure is directed to software applications that provide for a financial education. In various examples, the software applications allow parents to teach children financial responsibility.

In examples provided herein, the software applications allow parents or other guardians to educate children about finances. In some embodiments, the software applications provide communication services between the parents and children, which allow children to receive encouraging messages, communicate with others, etc. The software applications can also allow parents to control actions of the children, such as setting spending limits and access to certain services.

Further, the software applications can provide educational material and services relating to financial topics to the children. As part of this educational material, the software applications can provide gamification to various services to encourage learning. In addition, the software applications can allow the parents and/or children to set goals related to financial responsibilities, such as savings goals.

Finally, the software applications can be configured to understand the profiles of the children, such as ages and preferences, to tailor the financial educational services that are provided. Many other configurations are possible.

While the terms “child” and “parent” are used herein, these terms are used as examples. The child can be anyone who lacks a foundation in finance or otherwise needs assistance in that area. This will typically be an individual who is under the age of 20, although the examples are not so limited. The parent can be an actual parent of the child, a guardian of the child, other relative of the child, or adult otherwise given the role of overseeing the child. Many configurations are possible, and the terms “child” and “parent” should not be construed in a limiting way.

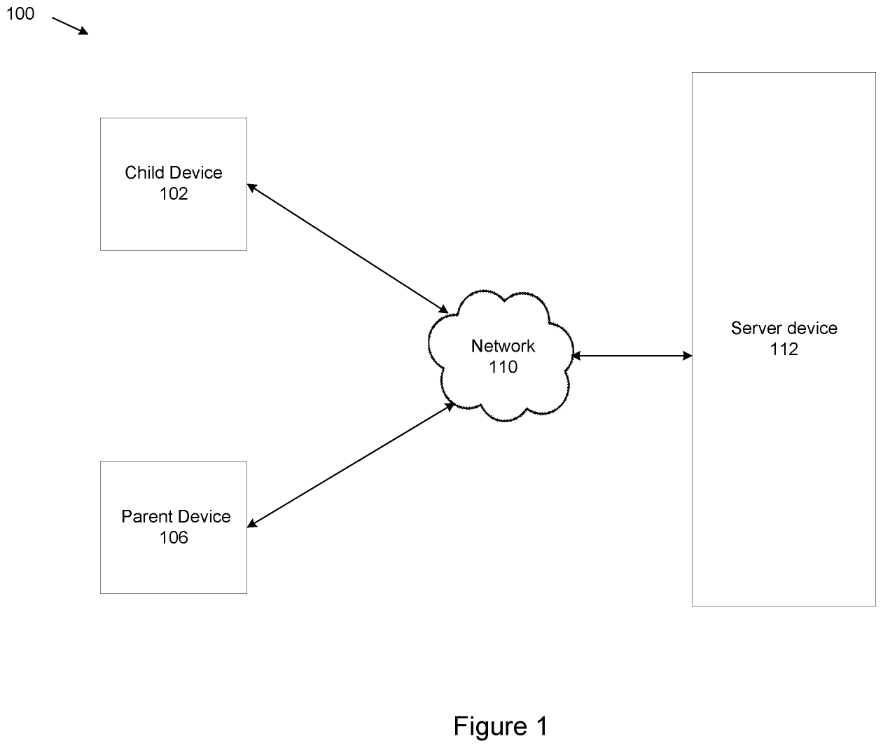

FIG. 1 schematically shows aspects of one example system 100 that facilitates the software applications that provide for a financial education. The system 100 includes a child device 102, a parent device 106, and a server device 112.

In these examples, the child device 102 is a computing device used by the child. The parent device 106 is a computing device that is used by the parent. The child device 102 and the parent device 106 can be the same device in some instances.

The server device 112 is a computing device that is typically managed by an entity associated with the parent and/or child. In one non-limiting example, the entity is a financial institution that provides financial services to customers, including the parent and/or the child. However, the concepts described herein are equally applicable to other types of entities.

Each of the devices 102, 106 and 112 may be implemented as one or more computing devices with at least one processor and memory. Example computing devices include a smartphone, a mobile computer, a desktop computer, a server computer, or other computing device or devices such as a server farm or cloud computing used to generate or receive data.

In this example, the child device 102 can be programmed to include one or more software applications in addition to other typical smartphone functionality. These software applications allow the child to conduct various online banking activities, such as accessing and checking balances, transferring money, making payments, etc. In addition, the software applications can be used to control certain functionality of the child device 102, as described further below.

In the examples shown, the child device 102 and the parent device 106 can be used to access educational information from the server device 112. For instance, the child device 102 and the parent device 106 can communicate with the server device 112 through a network 110. While only two client devices are shown in the example of the system 100, in reality there can be hundreds or thousands of devices that communicate with the server device 112.

The server device 112 can be programmed to deliver functionality to the child device 102 and the parent device 106. For example, in one embodiment, the server device 112 is one or more computers (typically a server farm or part of a cloud computing environment) that facilitates the functionality described herein.

The examples provided herein solve multiple technical problems. For instance, the examples provide a more efficient way to distribute educational content. The software applications described herein combine the technical aspects of the distribution of educational content along with providing the ability to manage one or more financial accounts.

Further, the examples provide the practical application of interfacing with one or more third party systems, such as payment or purchase systems. Further, the practical application extends to the ability to control one or more of the devices used by the child, including access to accounts, location of the device, etc. Many other technical advantages are provided.

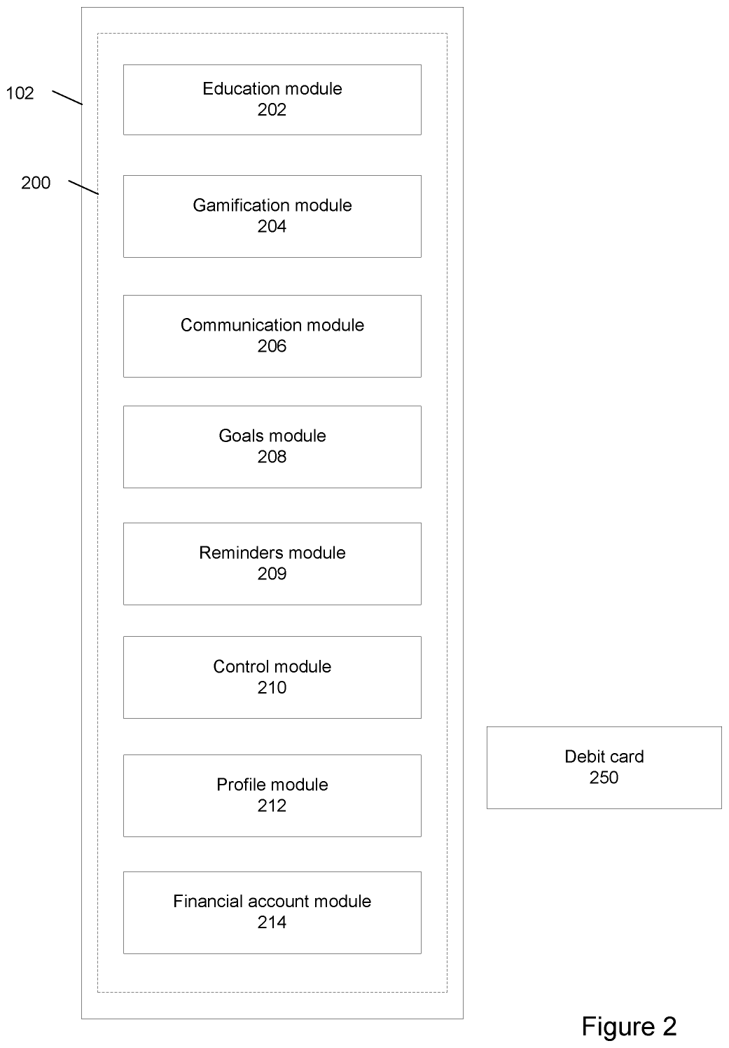

Referring now to FIG. 2, additional details are shown for the child device 102. The child device 102 can include various logical modules. These modules are created when the processor of the child device 102 executes instructions stored on the storage device to provide the functionality described herein.

More specifically, the child device 102 includes various software applications that are executed by the processor of the child device 102 according to the instructions stored on the storage media of the child device 102.

In some examples, the child device 102 executes a software application 200 that includes various modules that provide the financial education. As described further below, the software application 200 can be programmed to provide various functionality for the child and parent.

For example, the software application 200 can be used in conjunction with a debit card 250 (or other payment device, such as a credit card) to provide the child with typical banking services, such as the ability to use the debit card 250 to make purchases within the limits described herein. Further, the debit card 250 can include additional functionality, such as the ability to locate the debit card 250 using the software application 200 on the child device 102 or the parent device 106.

In this example, these example logical modules of the software application 200 on the child device 102 can include, without limitation: an education module 202; a gamification module 204; a communication module 206; a goals module 208; a reminders modules 209; a control module 210; a profile module 212, and a financial account module 214. As described herein, these modules communicate with the child device 102 and the parent device 106 to provide various aspects of the financial education.

For example, the software application 200 on the child device 102 can facilitate financial educational services and allow the child device 102 to communicate with the parent device 106 and the server device 112. The software application can further provide banking functionality, such as providing access to accounts (e.g., checking and savings accounts) for the child and facilitating typical banking services, such as deposits, withdrawals, and payments (e.g., through debit cards, etc.).

Similarly, the parent device 106 can include a similar software application that is installed on the parent device 106 to provide the functionality described herein.

For example, the education module 202 of the software application 200 is programmed to provide educational materials relating to finances and economics to the child device 102 for the child to consume. This can take many forms, from articles, stories, videos, games, etc. A variety of topics can be covered, such as information on how to use money wisely as a child, information about investments like stocks, how to start a business, and how to set goals.

For example, the education module 202 is programmed to teach the child about savings and investing. This can take the form of stories or videos that play on the child device 102 about these topics. The child can select these and/or the parent can suggest or require the child to consume certain of the educational material from the education module 202.

Further, the education module 202 can provide information on other aspects of finance and economics, such as mortgages, credit cards/scores, and/or loans. As described, this information can be presented on the child device 102 in formats that are easily understood by the child.

In addition, the education module 202 can provide information on problem areas relating to finances, such as: bad debt and predatory lending; inflation; phishing attacks; and protecting identity and financial data. Again, these can be presented in an age-appropriate fashion so that the child, using the child device 102, can understand the concepts and begin to learn about financial responsibility and success as the child grows.

More specifically, the educational materials can be tailored to the child's background, age, and experience level. For example, as described further below, the example system 100 can develop a profile of the child, including the child's gender, age, location, schooling, etc. This level of sophistication for the child can be used by the education module 202 to tailor the educational content provided to the child on the child device 102.

For instance, if the child is young, the educational materials can be basic information about saving money in a “virtual” piggy bank for later use. If the child is older and more sophisticated, the educational materials can be about starting a summer business or investments. The information can become more advanced as the child grows and matures.

In addition, the education module 202 can be programmed to track the child's interests beyond that relating to finance. For example, the child and/or parent can be asked to complete one or more surveys on the child device 102 or the parent device 106 that help to identify the child's interests. Such interests can include, for example, one or more of: science, history, math, English, geography, current events, etc. These interests can be used by the education module 202 to tailor the information provided to the child on the child device 102.

For instance, assume the child is motivated by science. The education module 202 can provide age-appropriate content relating to both finance and science to the child. In yet other examples, the financial information can be tailored by the education module 202 to better match the child's interests. In this example, the financial information can be provided with a more scientific approach given the child's interest in science. The education module 202 thereupon delivers the appropriate educational information to the child device 102 for consumption by the child.

The gamification module 204 of the software application 200 is programmed to provide additional educational information to the child in a format that encourages the child to use the child device 102 and learn. For instance, the gamification module 204 can provide one or more games that are age appropriate for the child. The games are used to teach the child about how to use money wisely. For instance, in one game, the child is able to save money and see how the money grows over time. For older children, the games can include such activities as investments and starting a business.

For instance, the gamification can include computer-based training that provides incentives for the child. In such an example, the child device 102 includes one or more games or other applications that teach the child how a business works and various aspects relating to how to start and own one in the future.

In some examples, the parent can use the parent device 106 to provide feedback on which educational information and games are provided to the child. The computer-based training can thereby be modified or otherwise tailored based upon the input from the parent device 106.

Various incentives can be provided as part of the gamification. For instance, as described further below, the child can receive certain awards for completing educational material. In other examples, the gamification can result in a monetary award, such as the parent device 106 transferring money (e.g., an allowance) to the child on the child device 102 upon successful complete of certain aspects of the gamification. Many alternatives are possible.

Such communications between the parent device 106 and the child device 102 can be accomplished by the example communication module 206 of the software application 200. The communication module 206 is generally programmed to allow the parent and the child to communicate with each other and third parties about financial subjects.

For instance, the parent device 106 can communicate positive or negative messages to the child device 102 as the child makes financial decisions. This can provide encouragement or correction to the child.

For example, the child can use the child device 102 to make purchases and payments, within certain constraints set by the parent, as described further below. As this occurs, the parent can keep track of the child's spending and send messages to the child on the child device 102 from the software application. For example, when the child deposits money in her account that meets the approval of the parent, the parent can use the parent device 106 to send a communication to the child device 102 with an encouraging message, like: “Good job saving money!”. In some examples, this message can be displayed within the software application on the child device 102 or displayed as other communications in a notification. Other applications on the parent device 106 can also be used to send such messages.

As described further below, the messages facilitated by the communication module 206 can also be requests from the child or parent relating to financial transactions. For instance, the child may need the parent's permission to make a desired purchase. The child device 102 can communicate with the parent device 106 to receive authorization.

For instance, the child can use the software application 200 on the child device 102 to request permission from the parent to spend $10 to purchase a toy. The software application on the parent device 106 receives the communication through the server device 112 and either approves or denies the request. The communication is then sent by through the server device 112 to the child device 102 with the approval or denial.

Further, the communication module 206 can be used to facilitate offers for the child to work to generate money, thereby further enhancing the child's understanding of finances. For instance, the child can use the child device 102 to make offers to work for the child's parents, family, neighbors, or friends. For instance, the child device 102 can include contact information for various people close to the child. The child can access the contacts and generate messages offering to do work.

In some examples, the communication module 206 requires the parent to approve the offer using the parent device 106 before the offer is delivered to the intended recipient. For instance, the parent can approve or modify and set any compensation or other aspects of the offer (like stay out later, or more gaming time). The parent can also approve to whom the offer to work can go (e.g., family, friends, neighbor, etc.). Examples of such offers can be to: cut the grass, babysit, pick up trash, clean windows, etc. Further, other parties can request services from the child. For instance, upon approval by the parent, the child can receive an offer from a neighbor to cut the neighbor's grass for $25. The child can then use the child device 102 to accept or reject the offer. Many other configurations are possible.

Similarly, the communication module 206 can be programmed to allow the child to transfer money to another party using the child device 102. For instance, the communication module 206 can allow the child to send or request money while be monitored by the parent using the parent device 106. In some examples, the parent can give permission on the software application of the parent device 106 for the child to send or request money. Upon approval, the money can be sent or requested from the relevant party.

For instance, if the child's friend lends the child money for lunch, the child can use the communication module 206 on the child device 102 to send money to the friend for repayment. In some examples, the communication module 206 can be programmed to communicate with existing money transfer applications to accomplish the actual transfer of the money. This can include, without limitation: Zelle; Venmo; Cash App; etc. Many configurations are possible.

In a similar fashion, the communication module 206 can also be programmed to allow others to provide gifts to the child. For instance, the child can use the child device 102 to setup a goal for savings for a particular item or charity. The child can then post this goal (e.g., through email or text, or to social media and other sites upon approval by the parent) and allow others to contribute to the goal. All such gifts can be approved before being posted by the child on the child device 102. For instance, the parent can approve to whom gifting request can go (e.g., family, friends, social media, etc.). As provided more below, the communication module 206 can be programmed to interface with third party platforms to accomplish the selection of the gift. Further, all gifts can be approved before going to the child on the child device 102. Examples of such gifting can go towards: college, a bicycle, a car, etc.

In some instances, the parent can request that family and friends give gifts that go towards specific child objectives instead of traditional gifts. For instance, the parent can request that gifts go directly into a college 529 plan or other college saving plan or into UTMA or UGMA or other child custodial accounts.

In other examples, the gifts can be associated with milestones for the child or holidays, such as Christmas, birthdays, graduation, etc. In one example, the child can make a list of what she wants using the software application 200 on the child device 102. Then, the list can be sent to the parent device 106 for approval by the parent and then forwarded to the appropriate people (e.g., family, friends, and/or social media).

As noted previously, the communication module 206 can be programmed to interface with third party sites to facilitate in communication. For instance, the communication module 206 can use an Application Programming Interface (API) or other configuration to interface with third party social media sites for posting of the child's gift requests. This is, again, after approval by the parent. This integration can allow the child to share goals, gifts, or accomplishments (goals like a field trip, gift for family, accomplishment like graduation) with such third party sites and facilitate the transfer of money to the child. Further, the integration can allow the child to advertise services on such sites as Yelp, Craigslist, Facebook, Twitter, etc.

For instance, the child can advertise a business like grass cutting, lawn clean-up, babysitting, house chores, etc. The communication module 206 is programmed to interface with the noted platforms to post the offer after approval by the parent. Further, the communication module 206 can facilitate communication to receive requests based upon the offer, along with the transfer of money once the job is completed. Again, all aspects of the process can be monitored and approved by the parent using the parent device 106.

As previously noted, the child can set various aspirations using the software application 200 on the child device 102. These aspirations can be managed by the goals module 208 of the software application 200.

In some examples, the goals can be monetary, as noted above. Further, the goals can be for services. For instance, the goals module 208 can be programmed to allow the child to create a goal associated with helping a third party (e.g., family, friends, neighbor, etc.). The parent can approve the goal before the goal is published or otherwise communicated to the relevant parties. Further, the goals module 208 can be programmed to track the progress towards achieving the goal and indicate once the goal is met.

For example, the child may make a goal to mow an elderly neighbor's lawn for a month using the goals module 208. Once the parent approves, the goal can be communicated to the neighbor. If accepted, the child can perform the mowing, and the goals module 208 can track that the mowing is performed each week. Other example goals include: help family next door whose house was damaged in storm; help with family or friend who is ill or in hospital; get money to go on school field trip; etc.

In yet another example, the goals module 208 can be programmed as a “virtual” piggy bank that allows the child to set savings goals. The goals module 208 can interface with a savings account of the child and track the child's savings. Further, the goals module 208 can allow the money to be saved in categories associated with different goals set up by the child or parent, such as money for a toy, money for a trip, etc. When money is saved by the child on the child device 102, the child can indicate to which category the money should be applied.

In addition to traditional savings, the goals module 208 can be programmed to provide other investment options for the child. For example, the goals module 208 can be programmed to allow the child to invest the money in other assets, such as stocks, money market accounts, and/or crypto currency. All investments can be approved by the parent on the parent device 106.

For example, depending on the child's age, the child can be allowed to select investment in various crypto currencies. The goals module 208 allows the child to track the investment and determine how the investment is performing. The goals module 208 can act as a traditional electronic wallet while providing functionality that makes such investments easier for the child.

In yet other examples, the goals module 208 can allow the child to practice investing in various products and track how such investments would perform over time. This allows the child to learn about investment without the risks associated with possible losses. Many configurations are possible.

The example reminders module 209 of the software application 200 can be programmed to set reminders associated with the goals. For instance, the child (or parent) can set reminders for certain financial or non-financial things the child needs to do, such as being associated with one or more goals. The child or parent can provide settings on frequency and timing of reminders. The child or parent can mark complete and can set financial or non-financial rewards.

The reminders module 209 can also interface with third parties to provide reminders associated with various aspects of the child's financial life, such as the child's school. In such examples, the reminders module 209 can provide reminders when various events occur, such as when the child's lunch fund is low or when money is due for a field trip at school. The reminders can also be non-financial in nature, such as a reminder to return a permission slip, stay late after school, or project due dates for a class. In some examples, the reminders module 209 can be programmed to provide the notifications for the reminders on the child device 102 and possibly the parent device 106. The reminders can take various forms, such as emails, texts, toast notifications, etc. Many other configurations are possible.

The example control module 210 of the software application 200 is programmed to allow the parent to control aspects of the child device 102. These aspects can include both the financial functionality provided by the software application 200, as well as the functioning of the child device 102. Examples of such control are provided as follows.

In some examples, the parent can control use of the child's funds through the parent device 106. For instance, the parent can turn the child's debit card 250 on and off so that the parent can control what is purchased and at what time. If the child tries to use the debit card 250 when it is turned off, the control module 210 delivers a notification that the debit card 250 cannot be used. For instance, the control module 210 can deliver a meme or other pop-up on the child device 102 notifying the child that the debit card 250 cannot be used.

In some examples, the parent can block the use of the debit card 250 or other money completely, for over a certain amount of money, and/or restrict to certain categories of use (e.g., can use to purchase food but not video games).

In addition, the control module 210 can be programmed to temporarily control the use of the child's funds. For instance, the parent device 106 can be used to set certain times of the day and/or week when the debit card 250 can be used. This can also be based upon categories. For instance, use of the debit card 250 can be limited by the control module 210 so that no gaming purchases can be made before 8 AM or past 9 PM. Further, the amounts of purchases in total can be set per day, per week, per month, etc.

Further, the control module 210 can be programmed to control other financial aspects of the child. For instance, the control module 210 can control other aspects of online purchasing. In one example, the control module 210 is programmed to integrate with online ordering for third party sites. As the child orders things online, the control module 210 can be used to monitor and oversee the purchases. The parent can thereby approve or disapprove of each purchase even when the funds being used may not be controlled directly by the software application 200.

In some examples, the full order is shown to the parent on the parent device 106 through scraping of the web page or integration using one or more APIs or other integration methods. For example, the child can go on an ordering application or site, such as Amazon, Grubhub, etc., and enter an order. However, the purchase will not be completed until the parent approves of the purchase on the parent device 106. For instance, when the control module 210 identifies that a purchase is being made, the control module 210 sends a notification detailing the purchase to the parent device 106. The parent can then approve or disapprove of the purchase. For example, the parent may approve of a purchase of food on Grubhub, but may disapprove of a purchase of slingshot on Amazon. Many configurations are possible.

In addition to controlling financial aspects, the software application 200 can control other aspects. For instance, the control module 210 can be programmed to allow the parent to set restrictions associated with the use of other aspects of the child device 102, such as playing games on it, sending text messages, making calls, etc. For example, the control module 210 can be used by the parent to limit the use of video games on the child device 102. If the child is punished, the control module 210 can limit or disallow playing of video games.

In addition, the software application 200 can be programmed to interface with other systems and devices. This can allow the control to extend beyond the child device 102. For instance, the control module 210 can be programmed through an API or other integration to communicate with the child's Xbox gaming system. Upon the setting of a restriction by the parent, the child device 102 can communicate with the Xbox to limit playing of games on the Xbox. Other example controls can apply to television, other computer usage, etc.

In addition, the software application 200 can be programmed to control other aspects for the child and parent. For instance, the control module 210 can be programmed to interface with or otherwise provide a browser that is controlled. In this instance, the secure browser can be controlled by the parent to vet the sites that are visited by the child on the child device 102. In some examples, the software application 200 allows for web sites to be blacklisted or whitelisted to control the sites that the child can visit on the child device 102. For instance, the parent can preload a “whitelist” of allowed sites. When the child attempts to visit a site that is not allowed, the child can make a request to the parent to approve the website to add to the list. The parent can then approve or deny the site on the parent device 106. Many configurations are possible.

In addition, the control module 210 can be programmed to access other aspects of the child device 102, such as location tracking. The control module 210 can report the location of the child device 102 to the parent device 106. For instance, the parent can set virtual perimeters and receive notifications when the device 102 leaves or enters the perimeters, such as when the child enters and leaves home or school.

Further, the parent can use the parent device 106 to see the current location of the child device 102. Further, the location of the physical debit card 250 can also be reported. For instance, the debit card 250 can include radio frequency identification (RFID) technology that allows the debit card 250 to report its location or otherwise respond when its location is being tracked. Many other configurations are possible.

In addition to control by the parent using the parent device 106, the control module 210 can provide certain levels of control for others. For instance, the parent can allow relatives and/or other parents or guardians to control aspects of the child device 102. For instance, another adult may be given control of the debit card 250 to simply turn it on and off. Further, this control can be given on a temporary basis, such as when the parent goes on a trip or there is an emergency (e.g., medical emergency at the hospital).

In another example, the control module 210 can be programmed to provide secure data storage for various other aspects associated with the child. This allows the child's data to be securely stored in one place for safety and controlled sharing.

For instance, data associated with one or more of the following can be securely stored by the control module 210: vaccination records; grades and teacher feedback (e.g., standardized testing scores); health records and prescription information (e.g., medication and glasses prescription); college applications; certifications; etc.

In addition to securely storing information about the child, the profile module 212 of the software application 200 can be programmed to build a profile of the child as the child interacts with the child device 102 and grows.

For instance, the profile module 212 can be programmed to assist the child in building a reference portfolio and an age-appropriate resume. This can include retaining a work history for the child, which the software application 200 can build automatically based upon past communications or can be manually-inputted by the child or parent.

In addition to showing work history, the profile module 212 can be programmed to integrate references to continue to build work opportunities. For instance, after each job is performed by the child, the employer (e.g., parent, neighbor, friend) can give a reference based upon the child's job performance. The parent and/or the child can choose to integrate and build the child's resume along with marketing material for future jobs using these references and job history.

In addition, the profile module 212 can tie together other aspects associated with the child, such as interests, experiences, etc. For example, as the child expresses interests using the education module 202, the profile module 212 can be programmed to log those interests.

Once created by the profile module 212, the profile can be used for various tasks beyond resume creation. For instance, the profile module 212 can be programmed to automatically complete school permission slips, and the parent can thereupon approve them using the parent device 106. Further, the profile module 212 can be used to complete other information, such as, without limitation: job applications; college applications; scholarship applications, etc. In other examples, the profile module 212 can be programmed to transfer information to other sites, such as for purchases, upon approval of the child and/or the parent. The parent can use the parent device 106 to control what information is shared with whom.

In addition, the profile module 212 can be configured to facilitate transitions for the child as the child grows, becomes more mature, and has different needs. For instance, the profile module 212 can assist in the transition of the child's checking or savings account from a “child” account to a full-featured account when the child becomes a certain age. For instance, when the child becomes 13-16 years old, the profile module 212 can be programmed to change the child's banking account to a full-featured account, pending approval by the parent.

Other activities are also possible. For instance, the profile module 212 can be programmed to recommend and assist in the following transitions as the child grows: open/transition to full-featured deposit/savings accounts; open/transition to investment accounts; automatically apply/open credit card accounts; automatically apply/open small business accounts including deposit, credit, merchant services; etc. Again, these are just examples. Further, the transitions can be automatically prompted or offered upon approval or request by the parent using the parent device 106. The parent maintains control as the child makes such transitions.

The example financial account module 214 of the software application 200 can be programmed to provide banking services to the child. For instance, the financial account module 214 can be programmed to allow the child to access the child's checking or savings account at a financial institution. The child can deposit, withdraw, and/or transfer money between accounts using the financial account module 214, pending approval by the parent.

In one example, the parent is associated with a first user credential and the child is associated with a second login credential. When accessing the financial account module 214 using the first user credential, the child has a restricted level of access to the financial account, and the parent has an unrestricted level of access to the financial account when accessing using the second user credential.

Further, the financial account module 214 can be programmed to interface with the debit card 250. This can facilitate payment by the child for products or services once approved by the parent on the parent device 106. Many other configurations are possible.

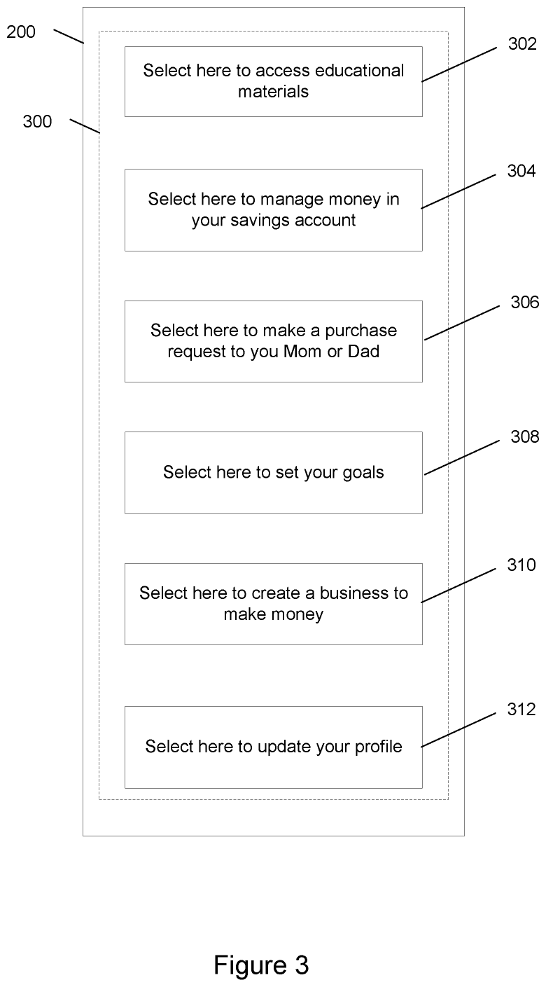

Referring now to FIG. 3, an example graphical user interface 300 of the software application 200 is shown. In this example, the interface 300 is rendered by the software application 200 on the child device 102. The example interface 300 generally includes a series of controls that allow the child to access the functionality of the software application 200 described herein. A similar interface can be provided for the parent on the parent device 106.

In this example, a control 302 can received selection by the child to access educational materials for the child. For instance, upon receiving selection of the control 302, the software application 200 can be programmed to provide a library of educational materials on finances that are tailored for the child. As described herein, these educational materials could be articles, videos, and/or games that are age- and level-appropriate for the child to assist the child in learning about finances.

Further, the example interface 300 includes a control 304 that, upon receiving selection, can allow the child to manage money in the child's savings account. This can include typical banking services, such as checking the balance of the savings account and transferring money to or from the savings account.

The example interface 300 includes a control 306 that, upon selection, provides the ability for the child to request permission to make a purchase from the parent on the parent device 106. For instance, upon selection, the software application 200 can identify details of the purchase (e.g., item description, vendor, cost, etc.) and send those details for approval. Upon approval by the parent on the parent device 106, the purchase can be consummated by the software application 200 on the child device 102.

The example interface 300 also includes a control 308 that, upon receipt of selection, can allow the child to set goals. For example, as described herein, the child can set various goals, such as a goal for saving money, for working, etc. The interface 300 can also let the child track those goals. For instance, if the goal is to save $100 during the summer, the interface 300 can provide how much has been saved and how much time remains. Many configurations are possible.

An example control 310 of the interface 300 allows the child to create a business upon receipt of selection. For instance, the software application 200 can provide educational material on how to start a business, along with functionality to allow the child to advertise and track the business. For instance, if the child wants to start a lemonade stand, the software application 200 can provide educational materials on the costs of starting and maintaining the stand. It can also help to track inventory and income for the stand and track dates when the stand is open. Many configurations are possible.

Finally, an example control 312 provides access to the child's profile upon selection. The child can add and update the profile, such as adding information associated with the child financial accounts, school, etc. As noted, the profile is accumulated for the child over time as the software application 200 interacts with the child.

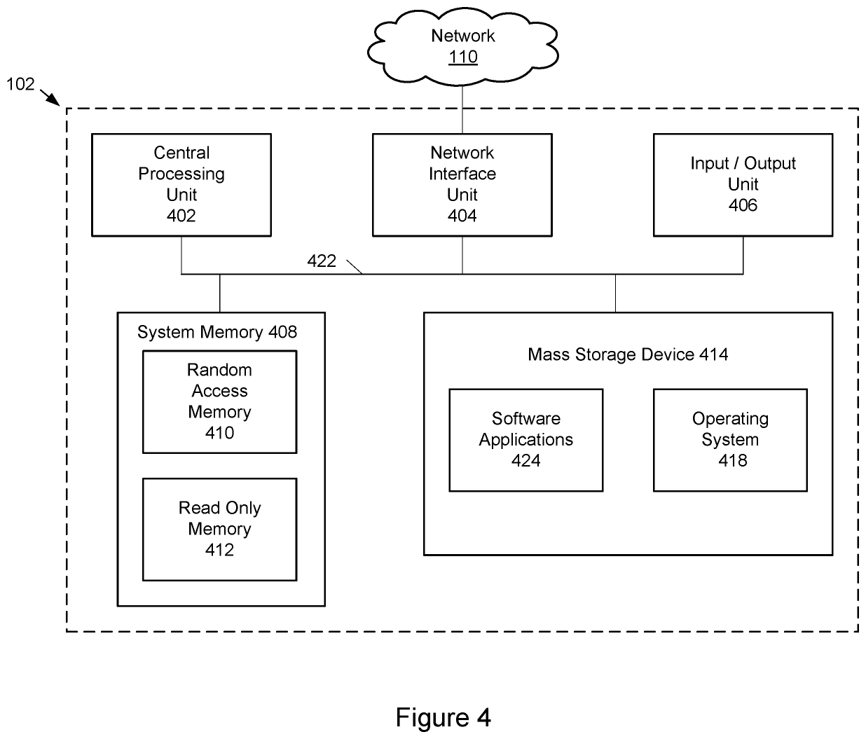

As illustrated in the embodiment of FIG. 4, the example child device 102 can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the child device 102, such as during startup, is stored in the ROM 412. The child device 102 further includes a mass storage device 414. The mass storage device 414 can store software instructions and data. A central processing unit, system memory, and mass storage device similar to that in FIG. 4 are also included in other computing devices disclosed herein (e.g., the devices 106, 112).

The mass storage device 414 is connected to the CPU 402 through a mass storage controller (not shown) connected to the system bus 422. The mass storage device 414 and its associated computer-readable data storage media provide non-volatile, non-transitory storage for the child device 102. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the child device 102.

According to various embodiments of the invention, the child device 102 may operate in a networked environment using logical connections to remote network devices through network 110, such as a wireless network, the Internet, or another type of network. The child device 102 may connect to network 110 through a network interface unit 404 connected to the system bus 422. It should be appreciated that the network interface unit 404 may also be utilized to connect to other types of networks and remote computing systems. The child device 102 also includes an input/output controller 406 for receiving and processing input from a number of other devices, including a touch user interface display screen or another type of input device, such as interfaces for receiving gestures, eye movements, interpreting brain waves, etc. Similarly, the input/output controller 406 may provide output to a touch user interface display screen or other output devices.

As mentioned briefly above, the mass storage device 414 and the RAM 410 of the child device 102 can store software instructions and data. The software instructions include an operating system 418 suitable for controlling the operation of the child device 102. The mass storage device 414 and/or the RAM 410 also store software instructions and applications 424, that when executed by the CPU 402, cause the child device 102 to provide the functionality of the child device 102 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for providing a financial education, comprising:
one or more processors; and
non-transitory computer-readable storage media encoding instructions which, when executed by the one or more processors, causes the computer system to generate:
a financial account module programmed to provide a first user and a second user access to a financial account, wherein the first user is associated with a first user credential, wherein the second user is associated with a second login credential, wherein the first user has a restricted level of access to the financial account, and wherein the second user has an unrestricted level of access to the financial account;
an education module programmed to provide educational material related to finances, the education module tailoring the educational material based upon a level of sophistication of the first user, wherein the level of sophistication is set by the second user or is determined based on an attribute of the first user; and
a communication module programmed to facilitate communication between the first user and the second user relating to the finances of the first user.

2. The computer system of claim 1, wherein the education module is further programmed to select the educational material based upon a profile for the first user, wherein the profile includes an age, a gender, and a location for the first user.

3. The computer system of claim 1, wherein the education module is further programmed to modify the educational material as the level of sophistication of the first user changes.

4. The computer system of claim 1, wherein the communication module is programmed to allow the first user to request permission from the second user relating to a purchase by the first user.

5. The computer system of claim 1, wherein the financial account module is programmed to allow the first user to transfer money to and from the financial account.

6. The computer system of claim 1, comprising further instructions which, when executed by the one or more processors, causes the computer system to generate a control module programmed to allow the second user to control aspects of the finances for the first user.

7. The computer system of claim 6, wherein the control module is further programmed to allow the second user to control use of a debit card of the first user.

8. The computer system of claim 6, wherein the control module is further programmed to allow the second user to approve or deny a purchase by the first user.

9. The computer system of claim 1, comprising further instructions which, when executed by the one or more processors, causes the computer system to generate:
a gamification module programmed to provide one or more games to facilitate the financial education;
a goals module programmed to allow the first user a financial goal, wherein the goals module tracks the financial goal; and
a reminder module programmed to provide a reminder to the first user for an event or task; and
a profile module programmed to capture information associated with the first user, the information including one or more of: bibliographic information; school information; and work information.

10. The computer system of claim 9,
wherein the communication module is further programmed to share graphics indicating a positive or negative message to the second user;
wherein the communication module is further programmed to communicate an offer or acceptance of a work opportunity or gift for the second user;
wherein the communication module is further programmed to send or receive money by the second user;
wherein the goals module is further programmed to provide a virtual piggy bank for storage of funds by the second user;
wherein the profile module is further programmed to track interests of the second user;
wherein the profile module is further programmed to develop a resume for the second user;
wherein the control module is further programmed to track a location of computing device of the second user;
wherein the control module is further programmed to control functionality of the computing device of the second user; and
wherein the control module is further programmed to securely store and share documents associated with the second user.

11. A computer-implemented method for providing a financial education, the method comprising:
providing, by a computing device, a first user and a second user access to a financial account, wherein the first user is associated with a first user credential, wherein the second user is associated with a second login credential, wherein the first user has a restricted level of access to the financial account, and wherein the second user has an unrestricted level of access to the financial account;
providing educational material related to finances, the education module tailoring the educational material based upon a level of sophistication of the first user, wherein the level of sophistication is set by the second user or is determined based on an attribute of the first user; and
facilitating communication between the first user and the second user relating to the finances of the first user.

12. The method of claim 11, further comprising selecting the educational material based upon a profile for the first user, wherein the profile includes an age, a gender, and a location for the first user.

13. The method of claim 11, further comprising modifying the educational material as the level of sophistication of the first user changes.

14. The method of claim 11, further comprising allowing the first user to request permission from the second user relating to a purchase by the first user.

15. The method of claim 11, further comprising allowing the first user to transfer money to and from the financial account.

16. The method of claim 11, further comprising allowing, by the computing device, the second user to control aspects of the finances for the first user.

17. The method of claim 16, further comprising allowing the second user to control use of a debit card of the first user.

18. The method of claim 16, further comprising allowing the second user to approve or deny a purchase by the first user.

19. The method of claim 11, further comprising:
allowing, by the computing device, the first user to create a financial goal; and
tracking, by the computing device, the financial goal.

20. The method of claim 11, further comprising capturing, by the computing device, information associated with the first user, the information including one or more of: bibliographic information; school information; and work information.
